(19) United States
(12) Patent Application Publication
(10) Pub. No.: US 2025/0102407 A1
(43) Pub. Date: Mar. 27, 2025

(54) METHOD AND SYSTEM FOR DETERMINING THE CONTENT OF AT LEAST ONE IMPURITY IN A CRYOGENIC LIQUID

(71) Applicant: L'Air Liquide, Societe Anonyme pour l'Etude et l’Exploitation des Procedes Georges Claude, Paris (FR)

(72) Inventors: Frederic CRAYSSAC, Paris (FR); Patrick LE BOT, Paris (FR); Daniel MACHON, Paris (FR)

(21) Appl. No.: 18/891,146

(22) Filed: Sep. 20, 2024

(30) Foreign Application Priority Data
Sep. 21, 2023 (FR) FR 2309983

(51) Int. Cl. G01N 1/40

(52) U.S. Cl. CPC G01N 1/4022; G01N 2001/4027

(57) ABSTRACT

The invention relates to a method for determining the content of an impurity in a cryogenic liquid, comprising the following steps: filling a vessel with an initial volume of cryogenic liquid, vaporizing all the cryogenic liquid in the vessel, and forming a solid or liquid phase of the impurity in the vessel, isolating the vessel against any exit of material, sending a determinable volume of gas into the vessel, capable of dissolving the liquid or solid phase of the impurity in the determinable volume of gas, isolating the vessel against any entry of material, sending the gas loaded with the impurity to a gas analyser, and determining the content of the impurity in the cryogenic liquid from a content of the impurity measured, by the gas analyser, in the gas loaded with the impurity.

### CROSS REFERENCE TO RELATED APPLICATIONS

This application claims the benefit of priority under 35 U.S.C. § 119 (a) and (b) to French patent application No. FR2309983, filed Sep. 21, 2023, which is herein incorporated by reference in its entirety.

### FIELD OF THE INVENTION

The present invention concerns the chemical industry and relates to a determination system for determining the content of at least one impurity dissolved in a cryogenic liquid sampled, for example, in a system for separating the gases in air, and to a corresponding determination method.

### BACKGROUND OF THE INVENTION

A system for separating the gases in air comprises low- and medium-pressure distillation columns for separating the various components of air. Although the air is purified before it enters the columns, impurities remain in the air supplied to the columns and are concentrated in particular in an oxygen vaporizer in one of the columns. To be specific, most of these impurities have a liquid/vapour equilibrium coefficient such that almost all of these impurities stay in the liquid phase of the vaporizer, with an infinitesimal part of the impurities leaving the vaporizer again, in the gas phase. The content of impurities in the liquid phase therefore increases with successive vaporization cycles and ultimately builds up in the form of a liquid or solid deposit in the aluminium matrix of the vaporizer.

Adsorption processes, implemented before distillation, make it possible to eliminate from the air supplied to the columns heavy hydrocarbons, in other words having more than four carbon atoms, and hydrocarbons having unsaturated bonds. The impurities which are barely or not at all caught by these adsorption processes are in particular light hydrocarbons and propane. Light hydrocarbons having one or two carbon atoms are highly soluble in oxygen, and therefore do not give rise to a pure phase which can react with the oxygen in the vaporizer. However, propane is relatively insoluble in oxygen and can thus give rise to a pure phase which, when it comes into contact with the liquid oxygen in the vaporizer, can lead to an explosive situation, in particular when the energy released by this impurity is sufficient to trigger combustion in the aluminium matrix of the vaporizer.

Moreover, even when the impurity present in the vaporizer is not reactive with oxygen, it accelerates the build-up of all the other impurities, and therefore also of impurities which are reactive with oxygen. This is in particular the case with carbon dioxide and nitrous oxide, which have a solidification temperature that is above the operating temperature of liquid oxygen. These impurities may not be caught by adsorption processes and give rise to a solid phase in the liquid oxygen in the vaporizer, which can block the vaporization ducts of the vaporizer. This mechanism, referred to as “dead end boiling”, accelerates the concentration of all the impurities contained in the liquid being vaporized, in particular hydrocarbons, and therefore increases the risk of combustion of the vaporization matrix.

It is therefore necessary to monitor the content of impurities entering the distillation columns and/or the oxygen bath of the vaporizer in order to maintain therein acceptable maximum amounts of impurities and to ensure the operating safety of the system for separating the gases in air.

One problem to be overcome is that the levels of impurities to be measured are extremely low, given the very low solubilities and liquid/vapour equilibrium coefficients of these impurities, especially for carbon dioxide and nitrous oxide. In order to be able to control acceptable maximum amounts of impurities, it is necessary to measure contents of less than 100 ppb (parts per billion), and preferentially between 10 and 50 ppb. These measurements may be continuous or be carried out at a frequency allowing action to be taken well before a critical content of impurities is reached.

Currently, the techniques for determining the content of impurities in air to be distilled or in oxygen in the vaporizer use complex equipment and require considerable operational skill. These techniques only use gas analysers, which require that the cryogenic liquid entering the distillation columns or the vaporizer be sampled and vaporized in special apparatus so that it can then be analysed. Preferably, the sample is taken at the inlet of the vaporizer, or at the outlet of the vaporizer, or between various vaporization stages as appropriate, given that the vaporizer is a critical point of the system for separating the gases in air.

These prior art techniques involve complete vaporization of the sample along with its impurities so as to obtain a gas to be analysed, in which the content of impurities is identical to the content of impurities in the sample of cryogenic liquid, vaporization being carried out under conditions which prevent the build-up of impurities in the device for sampling or vaporizing the sample, so as not to falsify the measurements of the gas analyser.

In order to facilitate the measurement of the content of impurities in the cryogenic liquid, the inventors have developed an apparatus and a method for analysing this content, which are described in documents FR3066596 and FR3066597. The apparatus allows vaporization of a large amount of a sample of cryogenic liquid to be analysed in a vessel, the gas thus vaporized being discharged in an open circuit, a quantity of residual cryogenic liquid in which the impurities of the sample are concentrated being retained at the end of this vaporization. The vessel is then kept closed and the residual quantity of cryogenic liquid is completely vaporized in the vessel, in such a way as to obtain a gas with a content of impurities which is much higher than that in the initial sample, and hence much easier to measure by a gas analyser.

This innovative approach requires that the quantity of impurities evaporating during the vaporization in an open circuit be negligible with respect to the quantity of impurities remaining in the residual cryogenic liquid, but also that the precise quantity of residual cryogenic liquid be known in order to accurately evaluate the impurities concentration factor between the volume of the sample of cryogenic liquid and the volume of residual cryogenic liquid after vaporization of almost all the cryogenic liquid sampled. By dividing the content of impurities measured by the gas analyser by this concentration factor, it is possible to determine the content of impurities in the cryogenic liquid sampled in the system for separating the gases in air.

The accuracy of this determination thus depends on the accuracy of the measurements of the quantity of cryogenic liquid sampled, of the quantity of residual cryogenic liquid and of the content of impurities in the residual cryogenic liquid, the latter measurement being performed by the gas analyser.

The quantity of cryogenic liquid sampled can easily be measured with an error rate of less than 2%, but the quantity of residual cryogenic liquid is more difficult to measure, and results in an error rate of more than 10% in some cases.

To be specific, in order for the impurities to be sufficiently concentrated in the residual cryogenic liquid, this liquid represents only around 1% of the quantity of cryogenic liquid sampled. To accurately measure this volume, several methods are possible.

A first method is based on measurement of the heating power used to vaporize the cryogenic liquid sampled. This first method requires that the heating power used for this vaporization alone be evaluated, and thus that the heat losses through the vessel also be evaluated. Moreover, this heating power is such (with respect to the power that would be necessary to vaporize the quantity of residual liquid) that it is difficult to know whether 98.9% or 99.1% of the cryogenic liquid sampled has been vaporized, which corresponds to an error rate of 10% in the measurement.

A second method consists in directly measuring the volume of residual cryogenic liquid, but since this volume is small relative to the volume of the sample of cryogenic liquid, the accuracy of this measurement is low, especially as the vaporization system developed by the inventors uses a heating surface of complex geometry in order to prevent, as much as possible, impurities escaping in the gas vaporized so that they are concentrated in the residual liquid. This heating surface prevents the formation of areas over-concentrated with impurities in the cryogenic liquid and vaporization to dryness on this heating surface, so as not to modify the liquid/vapour equilibrium coefficients in the vessel. Moreover, there is inertia in the vaporization system, which continues to vaporize during the measurement, further falsifying the latter.

A third, more accurate, method consists in measuring the quantity of residual liquid after vaporization thereof in the vessel isolated against any entry or any exit of material. To be specific, with the volume V of the vessel being known, by measuring the temperature T and the pressure P in the vessel after vaporization of all the residual liquid, the number n of moles of residual liquid is obtained by the relation PV=ZnRT, where R is the ideal gas constant (in Joules per mole and per Kelvin) and Z is the compressibility factor of the gas obtained by vaporization. However, this measurement requires a homogeneous temperature in the vessel, including in the pipework connecting the body of the vessel to the inlet and outlet valves, but since the temperature is measured just after vaporization, as the vessel is being brought to 70° C. (degrees Celsius), so as to be able to start on a new cycle of sampling and determination of the content of impurities in the cryogenic liquid sampled, the temperature within the vessel is not in fact homogeneous. This third method of measurement is therefore not as accurate as desired.

There is therefore a need to be able to determine the content of impurities in a cryogenic liquid sampled in a system for separating the gases in air, which is inexpensive while being sufficiently accurate to ensure the operating safety of the separation system.

### SUMMARY OF THE INVENTION

The present invention aims to overcome the above drawbacks at least partially by providing a method for determining the content of impurities dissolved in a cryogenic liquid and a corresponding determination system, which make it possible to concentrate the impurities before they are analysed by a gas analyser, while avoiding the problem of measuring a volume of residual cryogenic liquid.

To this end, the invention proposes a determination method for determining the content of at least one impurity dissolved in a cryogenic liquid, the at least one impurity being less volatile than the cryogenic liquid, comprising the following steps:
filling a vessel with an initial volume of cryogenic liquid,
vaporizing, within the vessel, all the cryogenic liquid present in the vessel, the pressure in the vessel during vaporization being lower than or equal to the pressure in the vessel during the filling step, and the gas resulting from the vaporization being discharged from the vessel, thus promoting the formation of a solid or liquid phase of the impurity in the vessel,
isolating the vessel against any exit of material,
sending a determinable volume of gas into the vessel, and heating the gas present in the vessel in such a way as to vaporize or sublimate the liquid or solid phase of the impurity in the gas present in the vessel, which is thus loaded with the impurity,
isolating the vessel against any entry of material,
sending the gas loaded with the impurity from the vessel to a gas analyser, and
determining the content of the impurity in the cryogenic liquid from a content of the impurity measured, by the gas analyser, in the gas loaded with the impurity.

The determination method according to the invention differs from the previous method developed by the inventors in that all the cryogenic liquid sampled, corresponding to the initial volume of cryogenic liquid, is vaporized. This initial volume is predetermined or in any case easy to measure. In order to avoid modifying this initial volume when filling the vessel, filling is of course carried out at a pressure and a temperature within the vessel preventing vaporization of the cryogenic liquid.

The gas, which then dissolves the crystals of impurities and/or the liquid phases of impurities, has a determinable volume, in that either the volume of gas with which the vessel is filled after the vaporization step is known, or it is easy to measure.

The crystals of impurities and/or the liquid phases of impurities correspond to almost all of the impurities present in the initial volume of cryogenic liquid, thanks to the conditions of vaporization, in an open circuit.

By virtue of the invention, the impurities present in the initial volume of cryogenic liquid are thus concentrated in a determinable volume of gas. The gas analyser therefore receives a gas the content of impurities of which is easier to determine than if it received a gas formed by vaporization of the initial volume of cryogenic liquid. This content of impurities corresponds to a number of moles of impurities in the determinable volume of gas which is almost identical to the number of moles of impurities in the initial volume of cryogenic liquid, which makes it possible to determine the content of impurities in the initial volume of cryogenic liquid.

The gas of the determinable volume of gas is for example selected from nitrogen, helium, or uncontaminated dry air. In other words, any gas which is devoid of impurities and can be loaded with the impurity to be measured may be used.

The determinable volume of gas sent into the vessel preferably corresponds to a concentration factor of greater than 30, and preferably greater than 50, between the content of impurity measured by the gas analyser and the corresponding content of impurity in the initial volume of cryogenic liquid. This concentration factor is the ratio between a gaseous volume corresponding to the initial volume of cryogenic liquid (if it were completely vaporized in a closed volume) and the volume of gas in which the liquid or solid phases of impurities were dissolved after vaporization of all the cryogenic liquid, under identical temperature and pressure conditions.

In one embodiment of the invention, the determinable volume of gas is taken from a tank of known volume, and the determination method comprises:
a first step of measuring the pressure and the temperature within the tank, before the step of sending the determinable volume of gas into the vessel,
a second step of measuring the pressure and the temperature within the tank, after the step of sending the determinable volume of gas into the vessel, and
a step of determining the determinable volume of gas or its mass as a function of the measurements taken during the first and second measurement steps, and as a function of the known volume of the tank. As a variant, it is not the determinable volume of gas or its mass that is determined, but a corresponding quantity, for example the corresponding number of moles of gas sent into the vessel to dissolve the impurity.

This embodiment of the invention is easy to put in place, since it only requires the integration of a tank, two valves and a small amount of pipework into the determination system previously developed by the inventors. One of the outlet valves of the tank makes it possible to fluidically connect the tank to the vessel, while the other inlet valve of the tank makes it possible to supply a gas such as nitrogen into the tank, each time the determination method according to the invention is implemented.

The known volume of the tank of course includes the internal volume of the tank as well as the internal volume of the pipework connecting the tank to each of the valves.

Before the step of sending the determinable volume of gas into the vessel, the gas in the tank is for example at ambient temperature and at a pressure of greater than 5 bar, and preferably between 5 and 10 bar. Thus, sending the gas from the tank to the vessel does not require complex treatment upstream of this step. Moreover, with the gas being at a pressure of greater than 5 bar in the tank, the temperature of the gas in the tank is homogenized, which makes it possible to reduce the error rate in determining the determinable volume of gas introduced into the vessel.

In this embodiment of the invention, the determination method according to the invention preferably comprises a step of filling the tank with the gas intended to be loaded with the impurity, before or during the vaporization step. Thus, the tank is filled with gas several dozen minutes before the step of sending the determinable volume of gas into the vessel, which further allows the temperature of the gas in the tank to be balanced and homogenized.

The determination method according to the invention is preferably repeated in cycles, fairly close together so as to be able to detect a high content of impurities sufficiently rapidly to be able to take action in time on the system for separating the gases in air. To reduce the duration of a cycle of determining the content of impurities in a sample of cryogenic liquid according to the invention, the step of filling the tank is for example carried out in parallel with a step of the determination method corresponding to the cycle underway or to the preceding cycle, for example during a step of sending the gas loaded with impurities to the gas analyser.

Also, in order to be able to restart as quickly as possible a cycle of determining the content of impurities in a new sample of cryogenic liquid, the step of sending the gas loaded with the impurity from the vessel to a gas analyser is followed by a step of cooling the vessel.

Furthermore, preferably, the vaporization step is controlled in such a way that only a very small amount of the impurities escape in the gas phase during this step.

Note that this vaporization step may be carried out at a pressure of greater than or equal to atmospheric pressure. To be specific, based on the values of thermodynamic equilibrium of the compounds involved, when the cryogenic liquid is maintained at 15 bar, the quantity of nitrous oxide, or of carbon dioxide, or of propane, escaping in the gas phase during vaporization in an open circuit is less than 2% of the quantity of impurities remaining in the liquid phase during this vaporization step.

However, preferably, in the determination method according to the invention, the pressure within the vessel during the vaporization step is brought to a value of between 0.2 bar and 0.3 bar and preferably equal to 0.2 bar. This makes it possible to lower the vaporization temperature and therefore to further reduce the liquid/vapour equilibrium coefficients. Moreover, this increases the difference in temperature between the heating surface and the cryogenic liquid, which makes it possible to reduce the duration of the vaporization step. The vaporization step is carried out for example under vacuum controlled by way of a vacuum-producing system such as a vacuum pump or an ejector.

The invention also relates to a determination system for determining the content of at least one impurity dissolved in a cryogenic liquid, the at least one impurity being less volatile than the cryogenic liquid, comprising:
a vessel capable of receiving an initial volume of the cryogenic liquid,
means for isolating the vessel against any exit of material once all of the cryogenic liquid has been vaporized by the vaporization means,
means for sending, into the vessel isolated by the isolation means, a determinable volume of gas, and means for vaporization or sublimation of the liquid or solid phase of the at least one impurity in such a way as to load the gas present in the vessel with the impurity, by heating the gas present in the vessel,
sending the gas loaded with the at least one impurity from the vessel to a gas analyser, and
determining the content of the at least one impurity in the cryogenic liquid from a content of the at least one impurity measured, by the gas analyser, in the gas loaded with the impurity.

In one embodiment of the invention, the means for sending a determinable volume of gas into the vessel comprise a tank of known volume and pipework connecting an outlet of the tank to an access to the vessel, and a valve capable of isolating the vessel from the tank.

The vaporization means are preferably capable of producing a thermosiphon effect, the vaporization means comprising for example a thermally conductive body generally in the shape of a cylinder hollowed out over its height by an intake duct and discharge ducts, which open out on the one hand on a face of the body delimiting a bottom part of the vessel, and on the other hand on a face of the body opposite the face delimiting a bottom part of the vessel, the vaporization means also comprising a manifold arranged on the opposite face and fluidically connecting the intake duct with the discharge ducts.

This thermosiphon effect makes it possible to agitate the cryogenic liquid and hence to prevent the formation of areas over-concentrated with impurities in the cryogenic liquid, which also prevents excessive vaporization of these impurities.

In this embodiment of the vaporization means, the discharge ducts surround for example the intake duct and have a diameter smaller than the intake duct.

The vaporization means moreover comprise, in this embodiment, at least one electric heating member arranged in a recess in the body proximal to the discharge ducts. For example, the vaporization means comprise several electric heating members in the form of heating cartridges, the body comprising spaces arranged around the discharge ducts and housing the heating cartridges, the spaces not opening out on the face of the body delimiting the bottom part of the vessel. The spaces are for example separated by recesses on the circumference of the body, over at least part of the height of the body, so as to increase the surface area for heat exchange with a coolant liquid during the cooling step.

So as to allow this cooling, a jacket surrounds the vaporization means for example, the jacket being configured to contain a coolant liquid coming into contact with the vaporization means. In this case, the opposite face opens out outside of the jacket, the intake and discharge ducts extending from the face delimiting the bottom part of the vessel, through the jacket. This makes it possible to easily supply power to the heating cartridges, and to insert them just as easily in the body, the opposite face comprising in particular holes for insertion of the heating cartridges in the spaces.

Lastly, the invention also relates to a system for separating the gases in air by cryogenic distillation, comprising a system for determining the content of at least one impurity dissolved in a cryogenic liquid according to the invention, means for sampling fluid circulating in the separation system, means for liquefaction of the fluid sampled, if it is gaseous, and means for sending the fluid sampled, and optionally liquefied, into the vessel so as to determine its impurity content.

Of course, the system and the method for determining the content of at least one impurity dissolved in a cryogenic liquid of the invention are applicable to other systems, for example to a system for separating another type of gas, from which carbon dioxide is to be separated, for example.

The system according to the invention for determining the content of at least one impurity dissolved in a cryogenic liquid, and the system for separating the gases in air according to the invention, have advantages similar to those of the method according to the invention for determining the content of at least one impurity in a cryogenic liquid.

### BRIEF DESCRIPTION OF THE DRAWINGS

The invention will be understood better from reading the following description and from studying the accompanying figures. These figures are given only by way of illustration and do not in any way limit the invention.

FIG. 1 depicts steps of a method according to the invention for determining the content of at least one impurity dissolved in a cryogenic liquid, in an embodiment of the invention,

FIG. 2 depicts a system for determining the content of at least one impurity dissolved in a cryogenic liquid according to the invention, in an embodiment of the invention, the system comprising in particular a vessel and vaporization means shown in section in the bottom part of the vessel,

FIG. 3 is a perspective view of an element of the vaporization means shown in FIG. 2, and

FIG. 4 is a perspective view of a section through the element of FIG. 3.

### DETAILED DESCRIPTION OF THE INVENTION

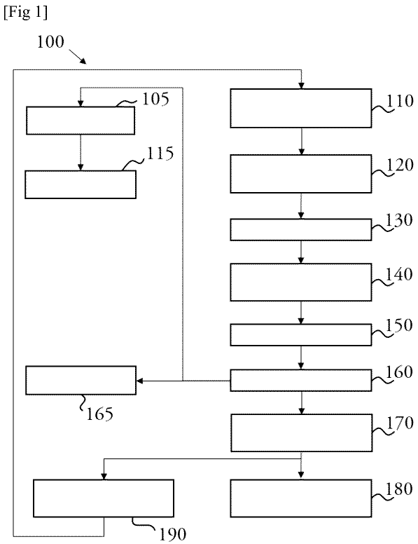

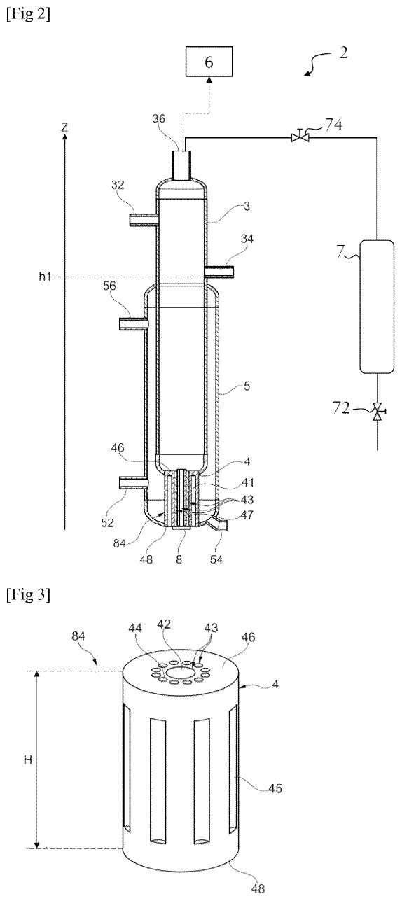

According to an embodiment of the invention shown in FIG. 1, a determination method 100 according to the invention, for determining the content of at least one impurity dissolved in a cryogenic liquid, is implemented by a determination system 2 according to the invention for determining the content of at least one impurity dissolved in a cryogenic liquid, shown in FIG. 2, this determination system 2 forming part, in this embodiment of the invention, of a system for separating the gases in air by cryogenic distillation.

The at least one impurity the content of which is determined is for example propane. The contents of impurities other than propane in the cryogenic liquid are of course also preferably determined by the determination method 100, the determination system 2 allowing such multiple determinations.

The system for separating the gases in air comprises means for sampling fluid circulating in the separation system. In this embodiment of the invention, it is assumed that these sampling means sample liquid oxygen at the inlet of an oxygen vaporizer of the gas separation system, this oxygen vaporizer being arranged in a distillation column of the gas separation system. The liquid oxygen thus sampled is sent into the determination system 2.

This system comprises in particular a vessel 3 in the form of a cylindrical vat, capable of containing liquid oxygen, and arranged vertically on legs, not shown. The vessel 3 comprises a liquid inlet 32, a liquid outlet 34 and a gas access 36, allowing gas to enter the vessel 3 or gas to exit the vessel 3.

The determination system 2 also comprises a tank 7 having a volume V_{R}, of 2 litres for example, fluidically connected to the gas access 36 of the vessel 3 by a first duct comprising a valve 74 making it possible to cut off the circulation of fluid between the tank 7 and the vessel 3. A second duct, for supplying gas, is connected to the tank 7 via a valve 72. Note that, in this application, the volume V_{R} includes the volume of the pipework as far as the valves 72 and 74.

Furthermore, the determination system 2 comprises means for measuring temperature and pressure in the tank 7.

Prior to a first implementation of a step of filling 110 of the vessel 3 of the determination method 100 according to the invention, the tank 7 is filled, during a step 105 of the determination method, with dinitrogen in the gaseous state, at ambient temperature and at a pressure of 6 bar absolute. Of course, as a variant, another type of gas and/or other conditions for storage of this gas in the tank 7 may be selected.

Several dozen minutes after the step 105 of filling the tank 7, the temperature of the gas is balanced in the tank 7. A first measurement of temperature and pressure in the tank 7 is then taken by means for measuring temperature and pressure in the tank 7, during a measurement step 115, providing a temperature Ti and a pressure Pi.

While the temperature of the dinitrogen in the tank 7 is being homogenized between steps 105 and 115 just described, the first step 110 of the determination method 100 is implemented for example.

The liquid oxygen sampled in the separation system corresponds to an initial volume of cryogenic liquid, i.e. in this case liquid oxygen, which is sent into the vessel 3, via the liquid inlet 32 on the vessel 3, during this first step 110 of the determination method 100, this first step 110 corresponding to filling of the vessel 3.

This initial volume of cryogenic liquid is predetermined. In order to obtain this precise volume, the vessel 3 is filled until the cryogenic liquid overflows from the vessel 3 via the liquid outlet 34, the position of which on the vessel 3 is determined in such a way that the vessel 3 is filled with the predetermined initial volume of cryogenic liquid when this liquid reaches the liquid outlet 34.

The height of the cryogenic liquid in the vessel 3 is then h1. This height is measured vertically relative to the ground along a vertical axis Z. By way of indication, in this embodiment of the invention, the vessel 3 has a capacity of 1.3 litres and the initial volume of cryogenic liquid is 0.8 litre.

During the filling step 110, the pressure and the temperature of the cryogenic liquid prevent vaporization thereof. The temperature of the cryogenic liquid is, specifically, lower than its vaporization temperature at the pressure to which it is subjected during this step.

The subsequent step of the determination method 100 is a step 120 of vaporization of the cryogenic liquid down to its last drop. In this step, the liquid inlet 32 and outlet 34 on the vessel 3 are closed, while the gas access 36, arranged at the top of the vessel 3, is open. To be specific, the cryogenic liquid converted into vapour is discharged during this vaporization step 120 via the gas outlet 36.

This vaporization is carried out by vaporization means 84 arranged in the lower part of the vessel 3, which bring the cryogenic liquid to its vaporization temperature, a vacuum being applied to obtain the vaporization pressure in the vessel 3 until a pressure of around 0.2 bar absolute is reached. By virtue of this low pressure, the vaporization temperature (or bubble point) is lower than at atmospheric pressure, which reduces the duration of the vaporization step 120. Moreover, this low pressure lowers the liquid/vapour equilibrium coefficients, preventing a large quantity of impurities from escaping in the gas phase.

The vaporization step 120 thus makes it possible to gradually concentrate the impurities present in the initial volume of cryogenic liquid, in the liquid phase of oxygen present in the vessel 3, until the liquid phase disappears and crystals of impurities or liquid phases of impurities are formed in the vessel 3.

The vaporization means 84 can be seen more particularly in FIG. 3. They comprise a copper body 4, generally in the shape of a cylinder of height H. The body 4 is arranged along this height H vertically in the lower part of the vessel 3, in such a way that a face 46 of the body, corresponding to a base of the cylinder, is arranged horizontally and forms a bottom part of the vessel 3. In other words, the base of the cylindrical vat forming the vessel 3 is partially constituted by the face 46 of the body 4, which lies flush with the aluminium walls of the cylindrical vat.

An opposite face 48 of the body 4, corresponding to the other base of the cylinder, is therefore arranged horizontally proximal to the ground relative to the face 46 forming the bottom part of the vessel 3.

The body 4 has, over its height, vertically arranged ducts 43 passing through it, namely an intake duct 42, at the centre of the body 4, and discharge ducts 44 surrounding the intake duct 42. The discharge ducts 44 have a smaller diameter than the intake duct 42. A copper manifold 8 is added on the opposite face 48 in such a way as to place the intake duct 42 and the discharge ducts 44 in fluidic communication. The manifold 8 forms part of the vaporization means 84.

Naturally, the lower part of the vessel 3 and the vaporization means 84 form sealed means for containing the cryogenic liquid.

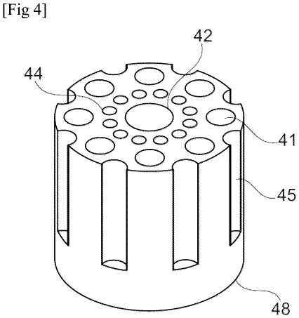

The vaporization means 84 also comprise heating cartridges housed in spaces 41 (visible in FIG. 4) arranged in the body 4 around the discharge ducts 44. These spaces 41 extend parallel to the discharge ducts 44 in the body 4, without opening out on the face 46 forming the bottom part of the vessel 3. They do however open out on the opposite face 48 in order to allow the insertion of the heating cartridges in these cavities 41 and the power supply to these heating cartridges.

Recesses 45, in the form of grooves, are made in the cylindrical surface of the body 4 between the spaces 41, so as in particular to increase the surface area for heat exchange between the body 4 and a coolant liquid intended to circulate in a jacket 5, surrounding the lower half of the vessel 3 and in particular a part of the vaporization means 84. More specifically, the jacket 5 takes the form of an annular jacket, a first circular edge of which surrounds the body 4, bordering the opposite face 48, and a second circular edge of which surrounds the vessel 3 slightly below the liquid outlet 34 on the vessel 3. The purpose of this jacket 5 will be described below.

The vaporization means 84 operate as a bath vaporizer with a thermosiphon effect in the discharge ducts 44. To be specific, during the vaporization step 120, the heating cartridges are supplied with power, and bring the temperature of the cryogenic liquid present in the discharge ducts 44 to its vaporization temperature, allowing the oxygen vaporized to escape, with very few impurities, to the gas outlet 36. Circulation is created by virtue of the thermal flows, the cryogenic liquid circulating in the intake duct 42 from the face 46 to the opposite face 48 of the body 4, then passing through the manifold 8 so as to supply the discharge ducts 44 with cryogenic liquid.

This circulation allows good agitation and good homogeneity of the cryogenic liquid in the vaporization means 84 and in particular on its heating surface formed by the inner surfaces of the discharge ducts 44, thus making it possible to maintain a liquid/vapour equilibrium coefficient favourable to keeping the impurities in the liquid phase of oxygen. Moreover, the heating surface stays wet by virtue of this circulation of liquid, for as long as possible before the crystallization or the liquefaction of the impurities, which also makes it possible to limit the impurities escaping in the gas phase of oxygen.

In order to avoid transmitting vaporization heat to the cryogenic liquid in the intake duct 42, the inner surface thereof is covered with a thermally insulating lining 47, for example made of Teflon®.

By virtue of the heating cartridges and the good conductivity of the body 4, the thermal flow in the vaporization means is controlled, which makes it possible to manage the temperature of the heating surface. In particular, the body 4, by virtue of its material, makes it possible to homogenize the temperature of the inner surfaces of the discharge ducts 44.

The latter have a circular section in order to promote good wetting of their inner surfaces, which are smooth or textured, for example porous or having fins in order to improve the exchange coefficient, increase the thermal flow and reduce the duration of this vaporization step 120. The low pressure applied in the vessel 3 makes it possible in particular to increase the difference in temperature between the temperature of the heating surface and the vaporization temperature of the liquid without the risk of too great a quantity of impurities escaping in the gas phase.

The configuration of the body 4, and in particular the arrangement of its ducts 43, makes it possible to have a wet heating surface of large size, for as long as possible during the vaporization step 120, even though the volume of residual cryogenic liquid is very small.

When the last drop of liquid oxygen is vaporized, a sharp increase in temperature is detected by a temperature probe present in the vaporization means 84, which naturally forms part of the determination system 2. The impurities are then present in the form of crystals or as one or more liquid phases of impurities in the vessel 3, depending on the impurities initially present in the liquid oxygen sampled.

The determination method next implements a step 130 of isolation of the vessel 3 against any exit of material; specifically, the liquid inlet 32, the liquid outlet 34 and the access 36 are closed, in order to keep the impurities in the vessel 3. Moreover, in this step 130, the heating cartridges are no longer supplied with power.

The next step 140 is the sending of a determinable volume of gas into the vessel 3, this gas being dinitrogen in this embodiment of the invention. To this end, the valve 74 is opened, sending some of the dinitrogen present in the tank 7 into the vessel 3, the latter still being isolated from the other circuits of the determination system. As the pressure in the tank 7 is greater than the pressure in the vessel 3, this sending of gas takes place naturally. By virtue of the difference in pressure between the tank 7 and the vessel 3, of the order of several bar, and of the relatively comparable sizes of the tank 7 and of the vessel 3, the gas which fills this vessel 3 has a relatively homogeneous temperature, which makes it possible to reduce the error rate in the average measurement of the quantity of gas introduced into the vessel 3, as explained below.

This step 140 comprises a heating phase, for example reusing the heating cartridges of the vaporization means, so as to vaporize, sublimate and heat up the gas present in the vessel 3 to a temperature at least greater than −70° C. (preferably greater than 0° C.).

The gas injected, in this case dinitrogen, must be “dry”, in other words without moisture, that is to say containing less than 1 ppm (part per million) of water and preferably less than 100 ppb (parts per billion) of water, and without the impurities to be analysed or other impurities which could disrupt the analysis of the impurities to be measured. Of course, other types of dry gas without the impurities to be analysed may be used, for example uncontaminated dry air, argon, etc.

The impurities in the liquid and/or solid state thus transition to the gaseous state and are dissolved in the dinitrogen thus introduced into the vessel 3, which is mixed with a remnant of gaseous dioxygen still remaining in the vessel 3 at the end of the vaporization step 120. This dilution of the impurities in the dinitrogen is quick, of the order of a few seconds. The impurities thus diluted in the dinitrogen may thus be easily analysed subsequently by a gas analyser 6 of the determination system.

The volume of dinitrogen introduced into the vessel 3 is optionally controlled, in particular as a function of the pressure measured in the tank 7 during step 105 or this step 140 of sending the determinable volume of gas, in order to obtain approximately the desired concentration factor and/or a volume of gas necessary for the analysis of the content of impurities in the dinitrogen loaded with impurities.

The next step 150 is the isolation of the vessel 3 against any entry or exit of material, by closing the valve 74. The determination method 100 then performs another measurement of temperature and of pressure in the tank 7 during a step 160, providing a temperature Tf and a pressure Pf.

Next, the gas access 36 is reopened in order to send the gaseous dinitrogen loaded with impurities into a gas analyser 6, during a step 170 of the determination method 100.

In parallel with this step 170 of sending the gaseous dinitrogen loaded with impurities into the gas analyser 6, the tank 7 is again filled with dinitrogen at ambient temperature, so as to reach the initial pressure Pi of 6 bar, during a new step 105, which will be followed several dozen minutes later by a new step 115 of measurement of the pressure and of the temperature in the tank 7. As a variant, step 105 takes place only 5 to 10 minutes before step 120 of vaporization of the cryogenic liquid in the vessel 3.

Again in parallel with this step 170 of sending the gaseous dinitrogen loaded with impurities into the gas analyser 6, the determination method 100 determines, during a step 165, the volume or the mass of dinitrogen introduced into the vessel 3 as a function of the measurements taken during the steps 115 and 160 of measurement of temperature and pressure in the tank 7, and of the known volume V_{R} of the tank 7. The mass M of dinitrogen introduced into the vessel 3 is in fact:
M=(Pi/Ti−Pf/Tf)*V_{R}*Mmol/R, where Mmol is the molar mass of the dinitrogen, * is the multiplication operator and/is the division operator.

The volume V of dinitrogen introduced into the vessel 3 is equal to:
V_{R}*density of the dinitrogen (at the pressure Pi and at the temperature Ti initially measured)/normal density of the dinitrogen (under normal conditions of pressure and temperature, i.e. 1.013 bar and 0° C.)−V_{R}*density of the dinitrogen (at the final pressure Pf and temperature Tf measured)/normal density of the dinitrogen (under normal conditions of pressure and temperature, i.e. 1.013 bar and 0° C.).

This determination of the quantity of dinitrogen introduced into the vessel 3 during step 140 is necessary so as to then determine the contents of impurities in the cryogenic liquid sampled, as explained below.

Once the contents of impurities in the dinitrogen have been determined by the analyser 6 during the step 170, and the quantity of dinitrogen introduced into the vessel 3 has been determined during step 165, the determination method 100 determines, during a step 180, the contents of impurities in the cryogenic liquid sampled at the inlet of the vaporizer of the system for separating the gases in air, and in particular its propane content.

The quantity of impurities initially present in the initial volume of cryogenic liquid sampled is almost identical to the quantity of impurities present in the determinable volume of gas introduced into the vessel 3 during step 140, by virtue of the very low proportion of impurities vaporized during step 120 of vaporization of the cryogenic liquid.

To refine the determination of the content of impurities in the cryogenic liquid sampled, the remaining volume or the remaining mass of gas in the vessel 3 just after the isolation thereof against any exit of material, and before sending the gas present in the tank 7 into the vessel 3, is added to the volume V or to the mass M of dinitrogen introduced into the vessel 3. This volume/this mass of gas remaining is calculated in a similar way by means of measurements of temperature and of pressure in the vessel 3 just after the isolation thereof against any exit of material, and before sending the gas present in the tank 7 into the vessel 3. In the case where this volume/this mass of gas remaining is calculated, the determination system 2 therefore comprises means for measuring the pressure and the temperature within the vessel 3.

Thus, the concentration of propane in this determinable volume of gas, determined by the analyser 6, makes it possible, by knowing the determinable volume of gas and the remaining volume of gas in the vessel, to calculate the number of moles of propane in this determinable volume of gas plus the remaining volume, this number of moles being almost identical to the number of moles of propane in the initial volume of cryogenic liquid sampled, and hence to determine the content of propane in the initial volume of cryogenic liquid sampled.

To be specific, it is sufficient to divide the content measured by the gas analyser during step 180, by a concentration factor equal to the gaseous volume corresponding to the initial volume of cryogenic liquid sampled, divided by the volume V of dinitrogen introduced into the vessel 3 plus the remaining volume of gas in the vessel 3 just before this introduction. The gaseous volume corresponding to the initial volume of cryogenic liquid sampled corresponds to the gaseous volume resulting from a complete vaporization of the initial volume of cryogenic liquid sampled in a closed volume, under temperature and pressure conditions that are of course identical to those corresponding to the volume V of dinitrogen introduced into the vessel 3 plus the remaining volume of gas in the vessel 3, to which this gaseous volume is added.

With respect to the prior art, this determination of the impurity content in the initial volume of cryogenic liquid sampled is much more accurate, since the determination of the number of moles of propane in the initial volume of cryogenic liquid sampled is itself more accurate, by virtue of the determination of the determinable volume of dinitrogen introduced into the vessel 3 in step 140, this being carried out with an error rate of less than 2%.

To be specific, the accuracy of this determination depends directly on the accuracy of the measurements of the pressure, temperature and volume of the tank, given the calculations carried out during step 165. In fact:
the pressure measurements are easily performed with an error rate of less than 0.05%,
the temperature measurements are easily performed with an error rate of less than 0.17%, and
the measurement of the volume V_{R} of the tank 7 is easily performed with an error rate of less than 0.05%; this measurement may be performed by measuring the mass of a liquid completely filling this volume.

In parallel with step 180 of determining the contents of impurities in the cryogenic liquid sampled at the inlet of the vaporizer of the system for separating the gases in air, the determination method 100 implements a step 190 of cooling of the vessel 3, during which a liquid at a temperature lower than the temperature of filling of the cryogenic liquid is sent into the jacket 5 via a liquid inlet 52 provided on the lower part of the jacket 5. This liquid is for example liquid oxygen. A gas outlet 56 in an upper part of the jacket 5 makes it possible to release a gas phase produced by evaporation of the liquid in the jacket 5 in contact with the warm wall of the vessel 3.

The coolant liquid is then discharged from the jacket 5 via an outlet 54 located in the bottom part of the jacket 5, and the determination system 2 is ready for a new implementation of the determination method 100 and in particular a new step 110 of filling of the vessel 3 with cryogenic liquid sampled in the system for separating the gases in air.

Preferably however, the cooling step takes place after the measurement of the content of the impurity by means of the analyser and after flushing of the volume of the vessel 3, that is to say after replacing its contents with a “clean” gas or after drawing its contents under vacuum by applying thereto a pressure at least lower than 0.25 bar absolute.

By virtue of the invention, each cycle of determination of the impurity content carried out by the determination method according to the invention may be performed within 30 to 60 minutes depending on the operating conditions, and generally within less than 40 minutes.

Of course, the invention is not limited to the examples which have just been described and numerous modifications may be made to these examples without departing from the scope of the invention. In particular, the sample of cryogenic liquid is, as a variant, taken at the inlet of the distillation columns of the system for separating the gases in air, or at the outlet of the oxygen vaporizer, or indeed between various vaporization stages as appropriate, and the gaseous oxygen may be liquefied beforehand before being analysed.

Moreover, the order in which the steps of the determination method 100 are carried out may be changed, in particular when certain steps may be carried out in parallel with other steps, for example the step of cooling of the vessel 3 may be carried out in parallel with the step of filling of the tank 7.

The invention is described in the context of a cryogenic liquid originating from the separation of air, such as oxygen, nitrogen or argon. It goes without saying that the invention applies to any cryogenic liquid, for example carbon dioxide, carbon monoxide, hydrogen, helium, methane, krypton, xenon, neon.

Lastly, the features of the various variant embodiments of the invention envisaged in this application may be combined so as to carry out the invention, as long as these variants are not mutually incompatible.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A method for determining a content of at least one impurity dissolved in a cryogenic liquid, the at least one impurity being less volatile than the cryogenic liquid, the method comprising the following steps:
filling a vessel with an initial volume of cryogenic liquid;
vaporizing, within the vessel, all the cryogenic liquid present in the vessel, the pressure in the vessel during vaporization being lower than or equal to the pressure in the vessel during the filling step, and the gas resulting from the vaporization being discharged from the vessel, thus promoting the formation of a solid or liquid phase of the impurity in the vessel,
isolating the vessel against any exit of material;
sending a determinable volume of gas into the vessel, and heating the gas present in the vessel in such a way as to vaporize or sublimate the liquid or solid phase of the impurity in the gas present in the vessel, which is thus loaded with the impurity;
isolating the vessel against any entry of material;
sending the gas loaded with the impurity from the vessel to a gas analyser; and
determining the content of the impurity in the cryogenic liquid from a content of the impurity measured, by the gas analyser, in the gas loaded with the impurity.

2. The method as claimed in claim 1, wherein the gas of the determinable volume of gas is selected from nitrogen, helium, or uncontaminated dry air.

3. The method as claimed in claim 1, wherein the determinable volume of gas is taken from a tank of known volume, and wherein the determination method comprises:
a first step of measuring the pressure and the temperature within the tank, before the step of sending the determinable volume of gas into the vessel,
a second step of measuring the pressure and the temperature within the tank, after the step of sending the determinable volume of gas into the vessel, and
a step of determining the determinable volume of gas or its mass as a function of the measurements taken during the first and second measurement steps, and as a function of the known volume of the tank.

4. The method for determining the content of at least one impurity dissolved in a cryogenic liquid according to claim 3, wherein, before the step of sending the determinable volume of gas into the vessel, the gas in the tank is at ambient temperature and at a pressure of greater than 5 bar, and preferably between 5 and 10 bar.

5. The method for determining the content of at least one impurity dissolved in a cryogenic liquid according to claim 3, comprising a step of filling the tank with the gas intended to be loaded with the impurity, before or during the vaporization step.

6. The method as claimed in claim 1, wherein the pressure within the vessel during the vaporization step is brought to a value of between 0.2 bar and 0.3 bar and preferably equal to 0.2 bar.

7. The method as claimed in claim 1, wherein the determinable volume of gas sent into the vessel corresponds to a concentration factor of greater than 30 between the content of impurity measured by the gas analyser and the corresponding content of impurity in the initial volume of cryogenic liquid.

8. The method as claimed in claim 1, wherein the step of sending the gas loaded with the impurity from the vessel to a gas analyser is followed by a step of cooling the vessel.

9. An apparatus configured to determine a content of at least one impurity dissolved in a cryogenic liquid, the at least one impurity being less volatile than the cryogenic liquid, the apparatus comprising:
a vessel configured to receive an initial volume of the cryogenic liquid;
means for isolating the vessel against any exit of material once all of the cryogenic liquid has been vaporized by the vaporization means;
means for sending, into the vessel isolated by the isolation means, a determinable volume of gas, and means for vaporization or sublimation of the solid or liquid phase of the at least one impurity in such a way as to load the gas present in the vessel with the impurity, by heating the gas present in the vessel; and
a gas analyser in fluid communication with the vessel, wherein the gas analyser is configured to receive the gas loaded with the at least one impurity from the vessel, wherein the gas analyser is further configured to determine the content of the at least one impurity in the cryogenic liquid from a content of the at least one impurity measured in the gas loaded with the impurity.

10. The apparatus as claimed in claim 9, wherein the means for sending a determinable volume of gas into the vessel comprise a tank of known volume and pipework connecting an outlet of the tank to an access to the vessel, and a valve capable of isolating the vessel from the tank.

11. The apparatus as claimed in claim 9, wherein the vaporization means are capable of producing a thermosiphon effect, the vaporization means comprising a thermally conductive body generally in the shape of a cylinder hollowed out over its height by an intake duct and discharge ducts, which open out on the one hand on a face of the body delimiting a bottom part of the vessel, and on the other hand on a face of the body opposite the face delimiting a bottom part of the vessel, the vaporization means also comprising a manifold arranged on the opposite face and fluidically connecting the intake duct with the discharge ducts.
